(19) United States
(12) Patent Application Publication
(10) Pub. No.: US 2008/0106044 A1
(43) Pub. Date: May 8, 2008

(54) SEALING SYSTEM AND GASKET WITH SPACES

(76) Inventor: Ngoc Minh Luong, Seldon, NY (US)

Correspondence Address: THORNE & HALAJIAN;APPLIED TECHNOLOGY CENTER, 111 WEST MAIN STREET, BAY SHORE, NY, 11706, US

(21) Appl. No.: 11/557,139

(22) Filed: Nov. 7, 2006

(51) Int. Cl. F02F 11/00

(52) U.S. Cl. 277/593

(57) ABSTRACT

A gasket for sealing at least two objects includes a body and at least one extension extending from the body and forming at least one space partially surrounded by the extension and the body. The gasket is configured to be placed in a channel of one object having a channel width which is substantially equal to the gasket width. A tongue of the other object is pressed into the channel and contacts at least one sealing surface of the extension. The space allows for increased compressibility of the gasket thus maintaining a proper seal under varying conditions.

### FIELD OF THE INVENTION

The present invention relates to gasket systems, gaskets and other flow control devices used to prevent leakage of fluids from one area to another, where the gasket includes spaces or voids to maintain a seal despite varying conditions such as varying compressive forces.

### BACKGROUND OF THE INVENTION

Gaskets are shaped according the surfaces to be sealed. Typically, gaskets are used to seal two objects to prevent leakage of a fluid from one object to the other under compression. The seal is typically created by pinching the gasket between adjoining surfaces of the two objects. Certain types of gaskets have channels that fit over mating surfaces of the two objects to provide a seal therebetween.

FIG. 1 illustrates such a conventional gasket system 100 where an H-shaped gasket 105 is shown separating a first object 110 from a second object 120. As shown in FIG. 1, one end of each of the first and second objects 110, 120 mates or fits snugly into a corresponding mating channel of the H-shaped gasket 105 thus providing a seal between the two objects 110, 120 under compressive forces 130, 140.

Variations in the compressive forces may result in degradation of the seal, either when too little or too much compressive force is applied. Even when the objects 110, 120 are properly connected together or to other objects to be sealed, such as when bolted or screwed using the correct amount of torque to provide a desired uniform compressive forces 130, 140, environmental changes affect and modify the compressive forces 130, 140 on the gasket 105 thus resulting in seal degradation. Environmental changes include changes in temperature, humidity, vibration, as well as aging of the gasket and other system elements such the fastening means, being via bolts, screws, rivets, adhesive and the like.

In conventional gaskets, the tolerances for the amount and uniformity of the compressive forces 130, 140 needed for a good seal are relatively small or tight. Further, larger compressive forces may deform the gasket and degrade the seal. Typically, conventional gaskets and sealing systems are configured to provide a seal upon mating with an object where there are no spaces between the mated object and the gasket. That is, the interface between the mated object and the gasket is devoid of discontinuities, and is fully mated to provide a seal. In fact, discontinuities are considered defects on a gasket surface, such as scratches and holes in what otherwise is a single and uniform mated sealing surface of the gasket devoid of spaces.

The single and uniform sealing surface of a conventional gasket requires relatively uniform compression for better sealing; otherwise some leakage may occur and cause damage, such as when the uniformity of the compressive forces changes due to environmental conditions and aging, for example. Thus, conventional gaskets suffer from seal degradation and leakage due to environmental conditions and aging.

Accordingly, there is a need for a better sealing system that provides a good seal, allows for larger tolerances in the compressive force and environmental conditions, and accepts a non-uniform compressive force without degradation of the seal.

### SUMMARY OF THE INVENTION

One object of the present systems and methods is to overcome the disadvantages of conventional gasket systems.

This and other objects are achieved by gaskets, gasket systems and methods where, for example, the gasket seals at least two objects. The gasket includes a body and at least one extension extending from the body and forming at least one space partially surrounded by the extension and the body. The gasket is configured to be placed in a channel of one object having a channel width which is substantially equal to the gasket width. A tongue of the other object is pressed into the channel and contacts at least one sealing surface of the extension. Illustratively, the gasket system may be compressed by at least 30% and still provides a good seal. The space (surrounded by the extension and the body) allows for increased compressibility of the gasket thus maintaining a proper seal under varying conditions.

Further areas of applicability of the present systems and methods will become apparent from the detailed description provided hereinafter. It should be understood that the detailed description and specific examples, while indicating exemplary embodiments of the systems and methods, are intended for purposes of illustration only and are not intended to limit the scope of the invention.

### BRIEF DESCRIPTION OF THE DRAWINGS

These and other features, aspects, and advantages of the apparatus, systems and methods of the present invention will become better understood from the following description, appended claims, and accompanying drawing where:

FIG. 1 shows a conventional gasket system;

FIG. 2 shows a gasket system according to one illustrative embodiment of the present invention; and

FIG. 3A-3H show various gaskets according to further illustrative embodiments of the present invention.

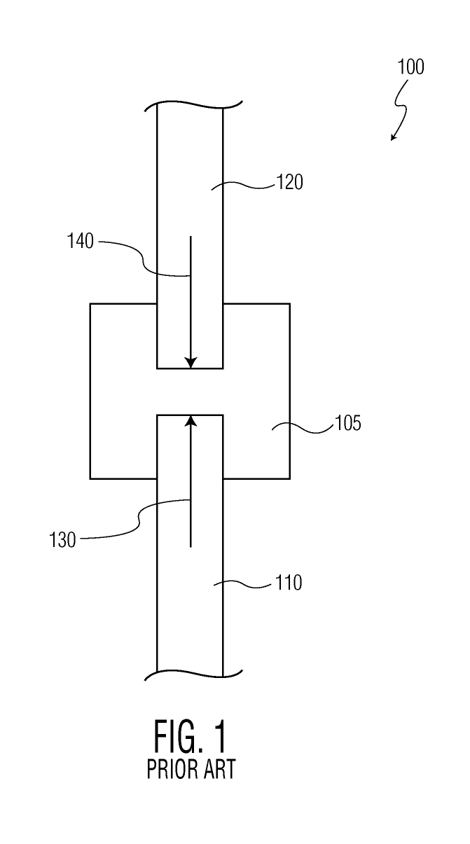

### DETAILED DESCRIPTION OF THE INVENTION

The following description of certain exemplary embodiments is merely exemplary in nature and is in no way intended to limit the invention, its application, or uses. In the following detailed description of embodiments of the present systems and methods, reference is made to the accompanying drawings which form a part hereof, and in which are shown, by way of illustration, specific embodiments in which the described systems and methods may be practiced. These embodiments are described in sufficient detail to enable those skilled in the art to practice the presently disclosed system and it is to be understood that other embodiments may be utilized and that structural and logical changes may be made without departing from the spirit and scope of the present system.

The following detailed description is therefore not to be taken in a limiting sense, and the scope of the present system is defined only by the appended claims. The leading digit(s) of the reference numbers in the figures herein typically correspond to the figure number, with the exception that identical components which appear in multiple figures are identified by the same reference numbers. Moreover, for the purpose of clarity, detailed descriptions of well-known devices and methods are omitted so as not to obscure the description of the present system.

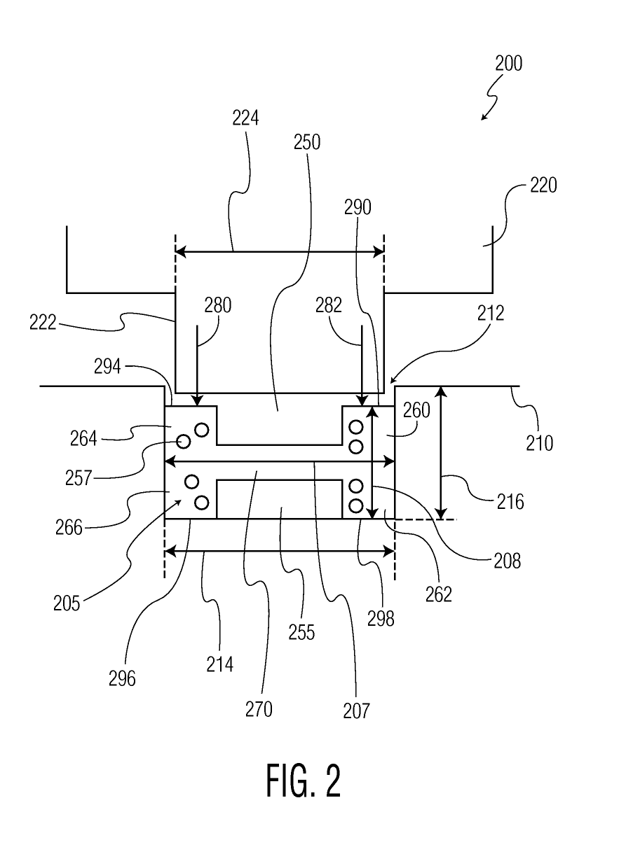

FIG. 2 shows a gasket system 200 comprising a gasket 205 having at least one extension for seal mating, such as four extensions 260, 262, 264, 266 extending from a body 270 of the gasket 205. The entire gasket 205 is inserted into a channel 212 of a first object 210 to be seal mated to a second object 220.

The width 207 of the gasket 205 is substantially the same or slightly less than the width 214 of the channel 212, so that the gasket 205 fits snuggly into the channel 212. The height 208 of the gasket 205 is less than the height 216 of the channel 212. Of course, the gasket width 207 and/or gasket height 208 may be the same or more than the channel width 214 and/or channel height 216, respectively, in the case where the gasket 205 is made of highly deformable material that allows enough compression (under the compressive force(s) 280, 282 applied on the gasket 205 by a tongue 222 of the second object 220, for example), so that the entire compressed gasket 205 totally fits inside the channel 212.

FIG. 2 also shows the tongue 222 of the second object 220, where the tongue 222 fits into the channel 212 of the first object 210. The width 224 of the tongue 222 is substantially the same or slightly less than the width 214 of the channel 212 to allow insertion of the tongue 222 into the channel 212 to provide the compressive force(s) 280, 282 over contacting surfaces of the gasket 205, namely the top or mating surfaces 290, 294 of the gasket extensions 260, 264.

As shown in FIG. 2, there is at least one space, where two spaces 250, 255 are shown, for example, between the gasket 205 and the channel 212, and/or between the gasket 205 and the tongue 222. It should be noted that since space 250 between the gasket extensions 260, 264 reduces the mating surface between the gasket and the tongue 222, less compressive force is needed to provide the desired compression of the gasket 205 as compared to a gasket having no space 250. For example, assume the mating surfaces 290, 294 of the gasket 250 are one fifth of a gasket having no space 250 (where the entire top surface of the gasket is the mating surface and receives a compressing force), and the desired amount of compressive force (e.g., forces 280, 282) is 1 Newton. To achieve the same compression using a gasket having no space 250, i.e., a gasket have five times larger mating surface as compared to the gasket 205 with the space 250, then the needed compressing force is also approximately five times, namely 5 Newtons. Thus, the gasket 205 having the space 250 allows for reduction of the compressive force needed to achieve a desired compression. In operation, typically the compressive force is approximately in the range of 20 to 40 Newtons, such as approximately 25-35 Newtons, and the gasket 205 is compressed approximately 25% to 35%. In an illustrative example where the gasket height 208 is approximately 3 mm-6 mm, then the gasket may compress up to approximately 0.2 mm-2.4 mm and maintain a proper seal.

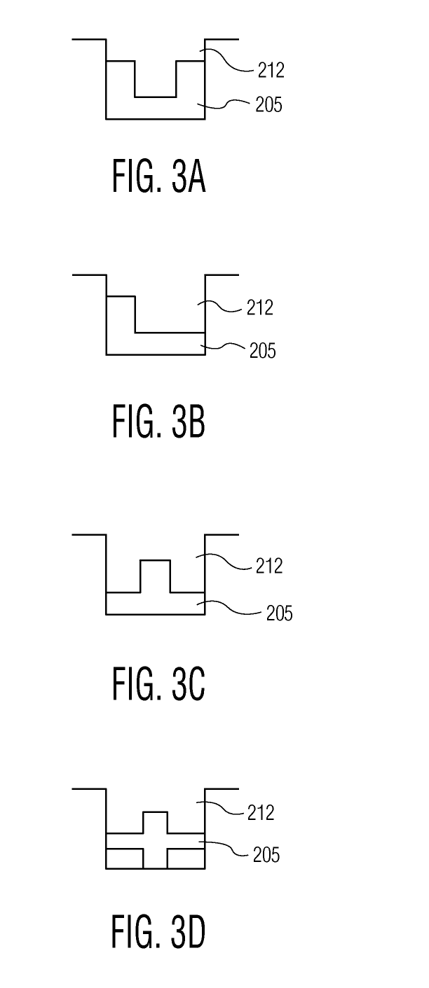

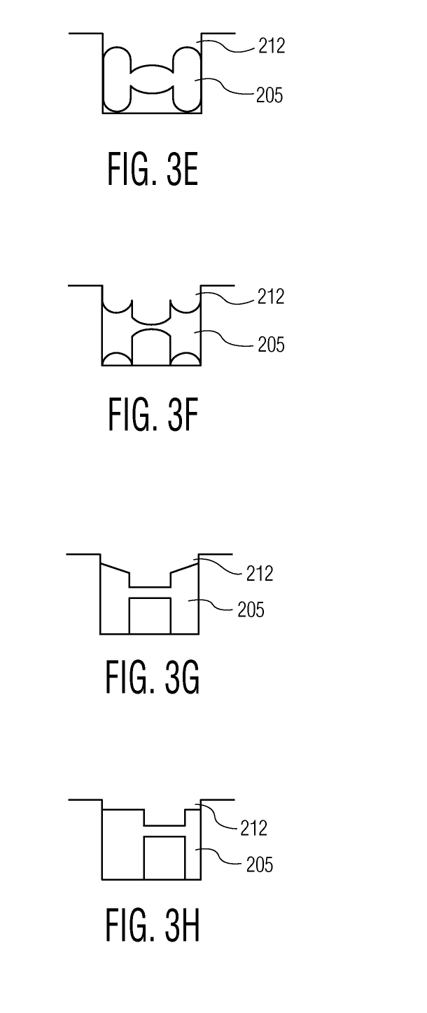

Illustratively, the gasket 205 has an H-shape, but it should be understood that the gasket may have any shape, such as a U-shape, an L-shape, a T-shape and/or a ‘plus sign’ shape (as shown in FIGS. 3A-3D for example), so long as there is at least one space between the gasket 205, the channel 212, and/or tongue 222. The space may be continuous or discontinuous and may be any shape, and may include spaces within the gasket itself, such as bubbles or voids 257 of any shape and/or size, uniform or non-uniform, disperse throughout the gasket material being any material which is deformable and/or resilient, such as rubber or silicon rubber, for example. Illustratively, the gasket system may be compressed by at least 30% and still provides a good seal.

The spaces 250, 255 may also have any shape and/or size by having different shaped/sized gasket body 270 and/or extensions 260, 262, 264, 266. Illustratively, FIG. 2 shows a gasket body 270 having a uniform width and/or shape, but may also have a varying width and/or shape including curved or wavy widths and/or shapes, as shown in the illustrative examples in FIGS. 3E-3H. Similarly, the extensions 260, 262, 264, 266 and their mating surfaces 290, 294, 296, 298 may have any width and/or shape, whether uniform or varying, in any combination. It should be understood that the various shaped gaskets 205 may be placed in the channel 212 in any desired way, such as an upright T instead of the inverted T shown in FIG. 3C, for example.

It should also be understood that the gasket, sealing systems and methods are applicable in many situations where a seal is desired, such as between two or more objects. Of course, as it would be apparent to one skilled in the art, any fastening means may be used to connect the two objects 210, 220 such as screws, bolts, rivets and/or adhesive.

Further, it is to be appreciated that any one of the above embodiments or processes may be combined with one or with one or more other embodiments or processes to provide even further improvements in sealing systems and methods.

Finally, the above-discussion is intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow. The specification and drawings are accordingly to be regarded in an illustrative manner and are not intended to limit the scope of the appended claims.

In interpreting the appended claims, it should be understood that:
a) the word “comprising” does not exclude the presence of other elements or acts that those listed in a given claim;
b) the word “a” or “an” preceding an element does not exclude the presence of a plurality of such elements;
c) any reference signs in the claims do not limit their scope;
d) several “means” may be represented by the same or different items or structures or functions;
e) any of the disclosed devices or portions thereof may be combined together or separated into further portions unless specifically stated otherwise; and
f) no specific sequence of acts or steps is intended to be required unless specifically indicated.

The claimed invention is:

1. A gasket system comprising:
a gasket having at least one extension for seal mating, the at least one extension extending from a body of the gasket; and
a channel configured to receive the gasket, the channel having a channel width which is substantially equal to a gasket width of the gasket.

2. The gasket system of claim 1, further comprising a tongue configured to fit within the channel.

3. The gasket system of claim 2, wherein a tongue width of the tongue is substantially equal to the channel width.

4. The gasket system of claim 2, wherein a seal is provided between the at least one extension and the tongue under a compressive force exerted on the tongue.

5. The gasket system of claim 2, wherein the tongue and the body form at least one space.

6. The gasket system of claim 1, wherein the body has a body width which has at least one of a uniform width and a varying width.

7. The gasket system of claim 1, wherein the body has a body width which has at least one of the uniform shape and a varying shape.

8. The gasket system of claim 1, further comprising a further extension extending from the body in a direction different from extension direction of the at least one extension.

9. The gasket system of claim 8, wherein the further extension and the at least one extension are of at least one of same shape, different shape, equal height, unequal height, equal width and unequal width.

10. The gasket system of claim 1, wherein at least one mating surface of the at least one extension is at least one of flat, tapered and curved.

11. A gasket comprising:
a body, and
at least one extension extending from the body and forming at least one space partially surrounded by the at least one extension and the body when a tongue is pressed on the at least one extension.

12. The gasket of claim 11, wherein the gasket is configured to fit within a channel of a first object, and the at least one extension has at least one mating surface for contacting the tongue of a second object and providing a seal between the first object and the second object.

13. The gasket of claim 12, wherein a channel width of the channel, a tongue width of the tongue, and a gasket width of the gasket are substantially equal.

14. The gasket of claim 12, wherein the seal is provided between the at least one extension and the tongue under a compressive force exerted on the tongue.

15. The gasket of claim 11, wherein the at least one space is configured to allow increased compressibility of the gasket when the tongue is pressed on the at least one extension.

16. The gasket of claim 11, wherein the body has a body width which has at least one of a uniform shape and a varying shape.

17. The gasket of claim 11, further comprising a further extension extending from the body in a direction different from extension direction of the at least one extension.

18. The gasket of claim 17, wherein the further extension and the at least one extension are of at least one of equal height, unequal height, equal width and unequal width.

19. The gasket of claim 11, wherein at least one mating surface of the extension is at least one of flat, tapered and curved.

20. A method of providing a seal between at least a first object and a second object comprising the acts of:
placing a gasket within a channel of the first object, the gasket having a body, and at least one extension extending from the body and forming at least one space partially surrounded by the at least one extension and the body; and
compressing the at least one extension with a tongue of the second object.
